(19) United States
(12) Patent Application Publication
(10) Pub. No.: US 2018/0198188 A1
(43) Pub. Date: Jul. 12, 2018

(54) METHOD AND APPARATUS FOR AN ANTENNA ALIGNMENT SYSTEM

(71) Applicant: Broadband Antenna Tracking Systems, Inc., Indianapolis, IN (US)

(72) Inventors: Steven D. Bensen, Zionsville, IN (US); Alex W. Eaton, Sheridan, IN (US); Robert B. Peterson, Brownsburg, IN (US); Matthew C. Creakbaum, Carmel, IN (US); Robert L. Bruder, Indianapolis, IN (US)

(21) Appl. No.: 15/916,816

(22) Filed: Mar. 9, 2018

Related U.S. Application Data
(63) Continuation-in-part of application No. 15/344,214, filed on Nov. 4, 2016.
(60) Provisional application No. 62/252,403, filed on Nov. 6, 2015.

(51) Int. Cl. H01Q 1/12; H01Q 3/06; H01Q 3/08

(52) U.S. Cl. CPC H01Q 1/1264; H01Q 3/08; H01Q 3/06

(57) ABSTRACT

An antenna alignment system comprising an antenna system including an antenna and a support system, and an alignment system including at least one actuator and a control unit, where the at least one actuator is configured to be coupled to the support system, and the control unit is configured to actuate the at least one actuator such that the antenna is moved in at least one direction.

### CROSS-REFERENCE TO RELATED APPLICATION

This application is a continuation-in-part of U.S. patent application Ser. No. 15/344,214, filed Nov. 4, 2016, and published as U.S. Patent Application Publication No. 2017/0133740, which claims priority to U.S. Provisional Patent Application No. 62/252,403, filed Nov. 6, 2015, the disclosures of which are expressly incorporated by reference herein.

### FIELD OF THE DISCLOSURE

The present disclosure relates generally to a method and apparatus for controlled antenna alignment, and more specifically, to a method and apparatus that optimizes antenna throughput through accurate aiming, alignment and fixed position capabilities.

### BACKGROUND OF THE DISCLOSURE

Various communications systems are known in the art which allow for point-to-point data connections to be established between two antenna systems. In current mobile communications systems, the majority of the antennas, are single structures providing omni-directional Radio Frequency (“RF”) coverage and are typically mounted in the same plane as other antennas on the top side of buildings and various mobile platforms. Commonly-used omni-directional antennas in such communications systems are not always capable of achieving the desired combination of operating distance and bandwidth speed necessary in modern data and video communications due to the difficulty of achieving perfect alignment. In addition, such systems are often time consuming to install. Therefore, improved communications systems such as an antenna alignment system are needed to assist in, for example, locating, locking onto, optimizing, and tracking the data links associated with at least two antenna systems in distinct physical locations. The present disclosure provides a method and apparatus that provides needed improvements in antenna alignment technology.

### SUMMARY OF THE DISCLOSURE

In one embodiment of the present disclosure, an antenna alignment system is provided. The antenna alignment system comprises an antenna system having an antenna and a support system, and an alignment system including at least one actuator and a control unit. The at least one actuator is configured to be coupled to the support system, and the control unit is configured to actuate the at least one actuator such that the antenna is moved in at least one direction.

In one aspect of the antenna alignment system, the at least one actuator includes a first actuator and a second actuator.

In another aspect of the antenna alignment system, the at least one direction includes a first direction and a second direction, and the first actuator is configured to pivot the antenna in the first direction and the second actuator is configured to pivot the antenna in the second direction.

In a further aspect of the antenna alignment system, the first direction is along an azimuth angle and the second direction is along an elevation angle.

In another aspect of the antenna alignment system, the antenna is a microwave antenna.

In a further aspect of the antenna alignment system, the at least one actuator is temporarily coupled to the support system, and the control unit is configured to actuate the at least one actuator to move the antenna in the at least one direction when the at least one actuator is temporarily coupled to the support system.

In another aspect of the antenna alignment system, the at least one actuator is continuously coupled to the support system.

In a further aspect of the antenna alignment system, the support system includes a support bracket having a plurality of azimuth couplers capable of translating within openings in the support bracket and a plurality of elevation couplers capable of translating within openings in the support bracket.

In another aspect of the antenna alignment system, the support bracket includes a main bracket, a coupling portion, an elevation link, and an azimuth link, wherein the main bracket includes an elevation pivot plate, a support plate, and a U-shaped bracket.

In a further aspect of the antenna alignment system, the control unit includes a wireless search algorithm configured to transmit instructions to the alignment system to actuate the at least one actuator such that the antenna is moved in the at least one direction.

In another embodiment of the present disclosure, a method for aligning a first antenna system with a second antenna system to establish a link is disclosed. The method comprises coupling an alignment system comprising at least one actuator and a control unit to the first antenna system, where the first antenna system comprises an antenna and a support system, initiating a software program within the control unit, transmitting instructions from the software program to the alignment system to actuate the at least one actuator, actuating the at least one actuator whereby the actuation of the at least one actuator causes the first antenna system to pivot and scan for the second antenna system in at least one direction, and removing the alignment system after the first antenna system is linked to the second antenna system.

In one aspect of the method, the at least one actuator includes a first actuator and a second actuator.

In another aspect of the method, the at least one direction includes a first direction and a second direction, and the first actuator is configured to cause the antenna to scan in the first direction and the second actuator is configure to cause the antenna to scan in the second direction.

In a further aspect of the method, the first direction is along an azimuth angle and the second direction is along an elevation angle.

In another aspect of the method, the first actuator causes the antenna to scan the azimuth angle for a range of ±15 degrees and the elevation angle for a range of ±20 degrees.

In a further aspect of the method, the antenna scans a first path along the azimuth angle for a plurality of degrees, and if no link is found, then the antenna scans the elevation angle for at least one degree before scanning a second path along the azimuth angle for a plurality of degrees, wherein the first path and the second path are parallel to one another.

In another aspect of the method, the software program includes a wireless search algorithm, whereby the control unit transmits the instructions to the alignment system to actuate the at least one actuator such that the antenna pivots and scans for the second antenna system in order to establish the link.

In yet another embodiment of the present disclosure, an apparatus for aligning a first antenna with a second antenna to establish a link between the first antenna and the second antenna is disclosed. The apparatus comprises a first actuator configured to pivot the first antenna in a first direction, a second actuator configured to pivot the first antenna in a second direction, and a control unit coupled to the first actuator and the second actuator and configured to actuate the first and second actuators such that the first antenna pivots and scans for the second antenna to establish the link, wherein the first actuator, the second actuator, and the control unit are removed from the first antenna once the link is established.

In one aspect of the apparatus, the first actuator is configured to pivot the first antenna along an elevation angle, and the second actuator is configured to pivot the first antenna along an azimuth angle.

In another aspect of the apparatus, the control unit is coupled to the first actuator, the second actuator, and a radio coupled to the first antenna.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 shows a perspective view of an embodiment of an antenna alignment system of the present disclosure including an antenna system and an alignment system;

FIG. 2 shows a perspective view of the antenna system of the antenna alignment system of FIG. 1 including an antenna, a radio, a support system, and a coupling bracket;

FIG. 3 shows a detailed view of the coupling bracket of the antenna system of FIG. 2;

FIG. 4 shows a detailed view of the support system of the antenna system of FIG. 2 including an elevation pivot plate, a support plate, a U-shaped bracket, an actuator support portion, and a coupling portion;

FIG. 5 shows another perspective view of the support system of FIG. 4;

FIG. 6A shows a perspective view of the elevation pivot plate of the support system of FIGS. 4 and 5;

FIG. 6B shows a perspective view of the support plate of the support system of FIGS. 4 and 5;

FIG. 6C shows a perspective view of the U-shaped bracket of the support system of FIGS. 4 and 5;

FIG. 6D shows a perspective view of the actuator support portion of the support system of FIGS. 4 and 5;

FIG. 6E shows another perspective view of the actuator support portion of FIG. 6D;

FIG. 6F shows a perspective view of a first clamping member of the coupling portion of the support system of FIGS. 4 and 5;

FIG. 6G shows a perspective view of a second clamping member of the coupling portion of the support system of FIGS. 4 and 5;

FIG. 7 shows a perspective view of a plurality of actuators of the alignment system of FIG. 1;

FIG. 8 shows a front view of a control unit of the alignment system of FIG. 1;

FIG. 9 shows a perspective view of the plurality of actuators of FIG. 7 coupled to the antenna system of FIG. 2;

FIG. 10 shows a detailed view of the plurality of actuators and the support system of the antenna alignment system of FIG. 9; and

FIG. 11 shows a second embodiment of an antenna alignment system of the present disclosure;

FIG. 12 shows a Quick Operation Guide of an embodiment of an antenna alignment system of the present disclosure;

FIG. 13 shows a third embodiment of an antenna alignment system of the present disclosure;

FIG. 14 shows a fourth embodiment of an antenna alignment system of the present disclosure; and

FIG. 15 shows a fifth embodiment of an antenna alignment system of the present disclosure with a radio unit, antenna, and control unit.

### DETAILED DESCRIPTION OF EMBODIMENTS

The embodiments disclosed herein are not intended to be exhaustive or to limit the disclosure to the precise forms disclosed in the following detailed description. Rather, the embodiments were chosen and described so that others skilled in the art may utilize their teachings.

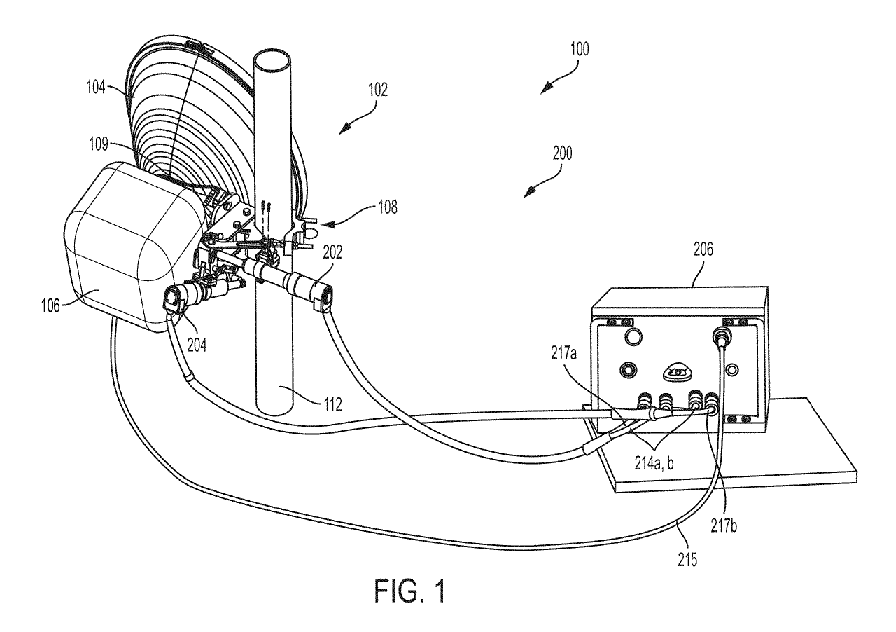

An antenna alignment system is disclosed for improving pointing or alignment accuracy of an antenna system and reducing alignment time between antenna systems during installation. Referring to FIG. 1, an embodiment of an antenna alignment system 100 (hereinafter “system 100”) of the present disclosure is shown. In the illustrative embodiment of FIG. 1, system 100 includes an antenna system 102 and an alignment system 200 configured to manipulate antenna system 102 in order to establish a robust data link with one or more distant communications systems (i.e., a second antenna alignment system 100 or any other antenna system).

### 1. Antenna System

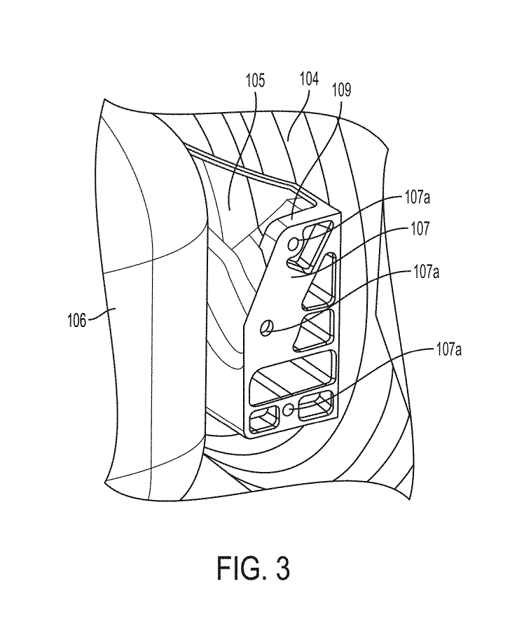

With reference to FIGS. 1-3, antenna system 102 of system 100 generally includes an antenna 104, a radio or outdoor unit 106, a support system 108, and a coupling bracket 109. In various embodiments, radio 106 is a conventional radio device configured to produce a plurality of radio signals or electromagnet waves of radio frequency (“RF”) signals. In certain embodiments, the signals may be modulated to include a variety of data such as sound/audio, video and/or other analog, and/or digital data transmissions. Similarly, antenna 104 may be a conventional antenna device configured to transmit the plurality of RF signals produced by radio 106. In one embodiment, antenna 104 may be a high gain narrow beam antenna and radio 106 may be a microwave/broadband radio.

Coupling bracket 109 of antenna system 102 is generally configured to couple antenna 104 to radio 106 and support system 108, and generally includes a first portion 105 and a second portion 107. First portion 105 includes at least one opening (not shown) configured to receive at least one coupler (not shown) for coupling antenna 104 to coupling bracket 109 and at least one opening (not shown) configured to receive at least one coupler (not shown) for coupling radio 106 to coupling bracket 109 and thus antenna 104. Second portion 107 includes a plurality of openings 107a configured to receive couplers (i.e., elevation couplers 140, 144, and 146) such that antenna 104 and radio 106 are coupled to support bracket 110 of support system 108.

a. Support System

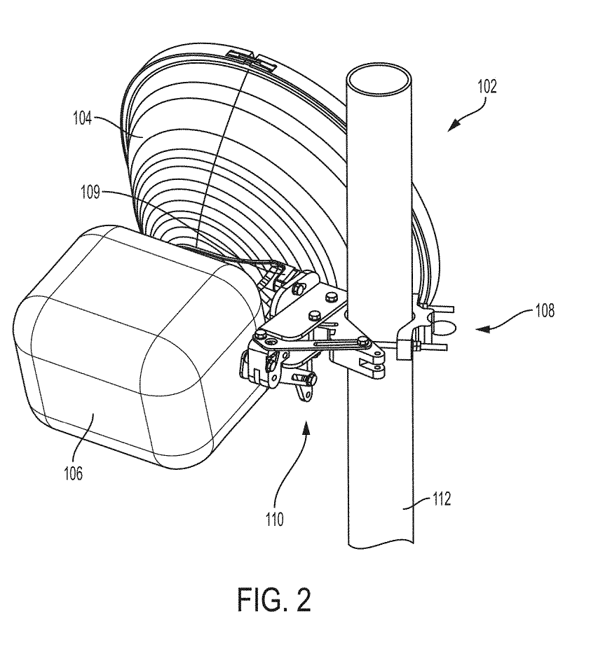

Referring to FIGS. 1 and 2, support system 108 of antenna system 102 is generally configured to support antenna 104, radio 106, and coupling bracket 109, and comprises a support bracket 110 and a main support 112. Support bracket 110 is configured to couple main support 112 to coupling bracket 109 such that main support 112 supports antenna 104 and radio 106 through coupling bracket 109 and support bracket 110. In various embodiments, main support 112 may be a shaft, pipe, rod, or any other support structure or device configured to support antenna 104, radio 106, and coupling bracket 109 via support bracket 110.

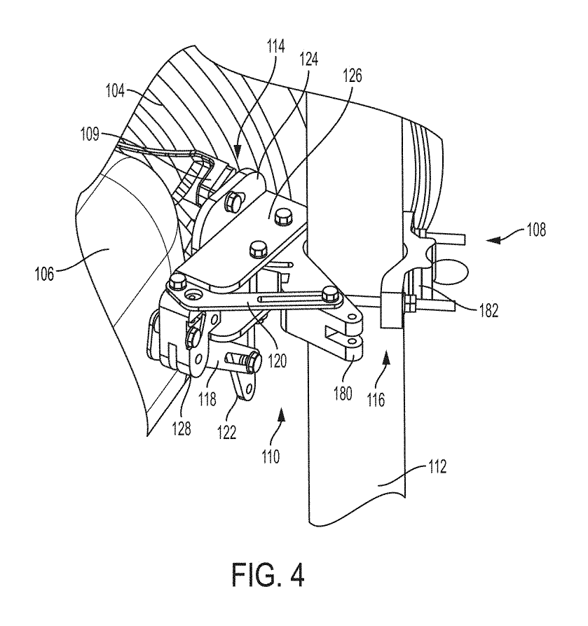

Referring now to FIG. 4, support bracket 110 of support system 108 comprises a main bracket portion 114, a coupling portion 116, an elevation link 118, and an azimuth link 120. Main bracket portion 114 is configured to couple to coupling bracket 109 and/or antenna 104, and coupling portion 116 is configured to couple to main support 112 and main bracket portion 114. In various embodiments, elevation link 118 may be configured to couple various components of main bracket portion 114, and azimuth link 120 may be configured to couple main bracket portion 114 to coupling portion 116.

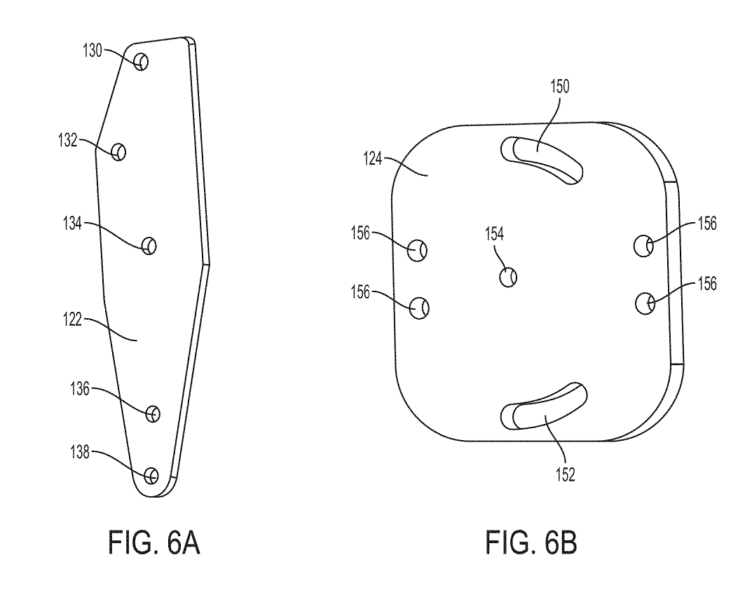

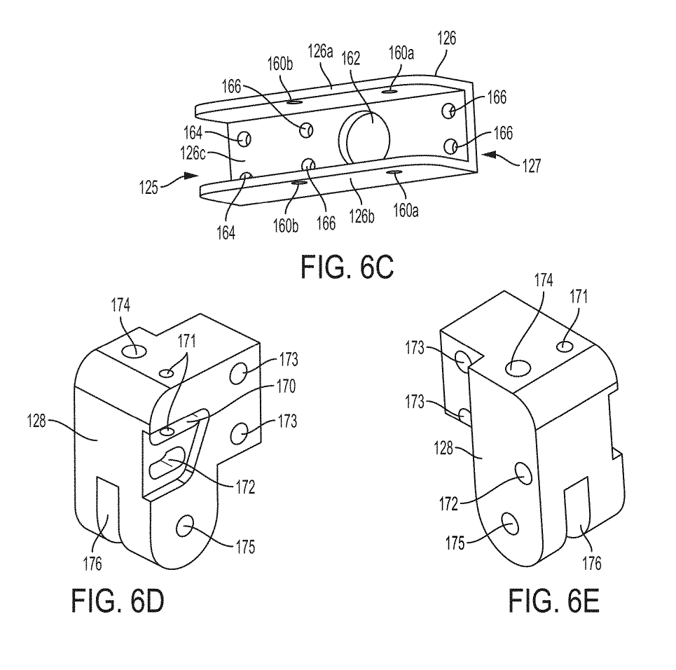

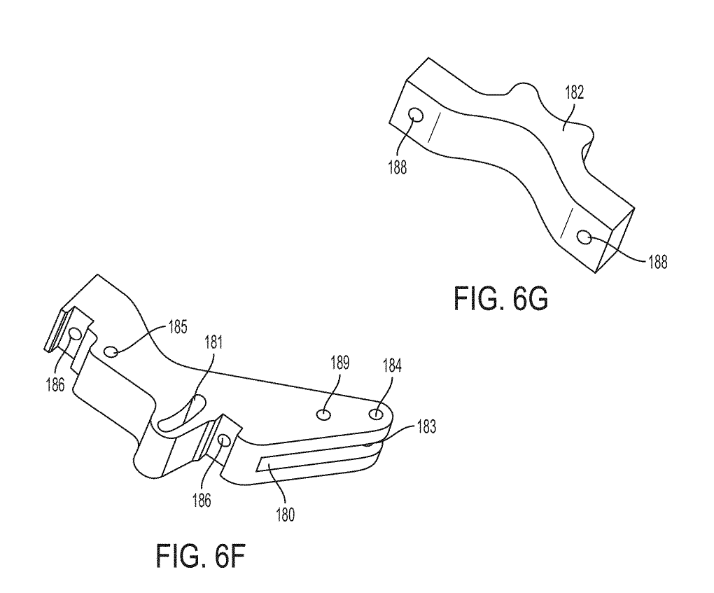

With reference to FIGS. 4, 5, and 6A-G, main bracket portion 114 of support bracket 110 typically includes an elevation pivot plate 122, a support plate 124, a U-shaped bracket 126, and an actuator support portion 128. In various embodiments, support plate 124 is coupled between elevation pivot plate 122 and U-shaped bracket 126, and actuator support portion 128 is coupled to a first end 125 of U-shaped bracket 126 spaced apart from elevation pivot plate 122 and support plate 124. In one embodiment, elevation pivot plate 122 and support plate 124 are coupled to U-shaped bracket 126 at and/or adjacent to a second end 127 of U-shaped bracket 126.

As shown in FIGS. 4, 5, and 6A, elevation pivot plate 122 of main bracket 114 extends vertically between coupling bracket 109 and support plate 124, and generally includes a first opening 130 configured to receive a first elevation coupler 140 which may be fixedly or pivotably coupled to elevation pivot plate 122, a second opening 132 configured to receive a plate coupler 142 which may be fixedly or pivotably coupled to elevation pivot plate 122, a third opening 134 configured to receive a second elevation coupler 144 which may be fixedly or pivotably coupled to elevation pivot plate 122, a fourth opening 136 configured to receive a third elevation coupler 146 which may be fixedly or pivotably coupled to elevation pivot plate 122, and a fifth opening 138 configured to receive an elevation actuator coupler 148 for coupling second actuator 204 to elevation pivot plate 122. In various embodiments, elevation couplers 140, 144, and 146 may be pivotably coupled to elevation pivot plate 122 prior to or during alignment of antenna system 102 and fixedly coupled to elevation pivot plate 122 once a link is established between two antenna systems.

Referring now to FIGS. 4, 5, and 6B, support plate 124 of main bracket 114 is positioned between elevation pivot plate 122 and U-shaped bracket 126. Support plate 124 generally includes a first curved elevation opening 150 configured to receive first elevation coupler 140 such that first elevation coupler 140, which is coupled to elevation pivot plate 122, may extend through and translate within opening 150, a second curved elevation opening 152 configured to receive second elevation coupler 144 such that second elevation coupler 144, which is coupled to elevation pivot plate 122 may extend through and translate within opening 152, a central opening 154 configured to receive plate coupler 142, which couples support plate 124 and elevation pivot plate 122, and a plurality of openings 156 configured to receive couplers 158 such that support plate 124 and U-shaped bracket 126 may be coupled together. In various embodiments, support plate 124 may include four openings 156 for receiving four couplers 158 for coupling support plate 124 to U-shaped bracket 126.

With reference to FIGS. 4, 5, and 6C, U-shaped bracket 126 of main bracket 114 generally includes a first horizontal plate 126a and a second horizontal plate 126b, where first horizontal plate 126a is coupled to second horizontal plate 126b via a vertical plate 126c. First horizontal plate 126a and second horizontal plate 126b each include at least one opening 160 configured to receive a coupler 161, 163 for coupling U-shaped bracket 126 to coupling portion 116. In various embodiments, first and second horizontal plates 126a and 126b each include a first opening 160a configured to receive coupler 161 and a second opening 160b configured to receive a first azimuth coupler 163 which may be fixedly or pivotably coupled to U-shaped bracket 126. In addition, vertical plate 126c generally includes a first opening 162 configured to surround plate coupler 142 coupling support plate 124 and elevation pivot plate 122, a plurality of openings 164 configured to receive couplers 165 for coupling actuator support portion 128 to vertical plate 126c, and a plurality of openings 166 configured to receive couplers 158 for coupling U-shaped bracket 126 to support plate 124. In various embodiments, vertical plate 126c includes four openings 166 configured to receive four couplers 158 for coupling U-shaped bracket 126 to support plate 124 and two openings 164 configured to receiver two couplers 165 for coupling actuator support portion 128 to vertical plate 126c of U-shaped bracket 126.

Referring now to FIGS. 4, 5, 6D and 6E, actuator support portion 128 of main bracket 114 generally includes a first opening 170 for receiving a portion of first actuator 202 such that first actuator 202 may be coupled to and supported by actuator support portion 128. In addition, actuator support portion 128 may further include a second opening 171 for receiving a securing pin 205 of first actuator 202 such that first actuator 202 may be secured to actuator support portion 128. Furthermore, actuation support portion 128 may include a third opening 172 for receiving a coupler 141 such that actuator support portion 128 may be coupled to elevation link 118, a fourth opening 173 for receiving coupler 165 such that actuator support portion 128 may be coupled to U-shaped bracket 126, a fifth opening 174 for receiving a coupler 169 such that azimuth link 120 may be coupled to actuator support portion 128, a U-shaped coupler 176 for receiving a portion of second actuator 204 such that second actuator 204 may be coupled to and supported by actuator support portion 128, and/or a sixth opening 175 configured to receiving a pin 208 of second actuator 204 such that second actuator 204 may be secured to actuator support portion 128. In various embodiments, actuator support portion 128 may include a plurality of openings 173 for receiving a plurality of couplers 165 for coupling actuator support portion 128 to U-shaped bracket 126. For example, actuator support portion 128 may include two openings 173 for receiving two separate couplers 165 for coupling actuator support portion 128 to U-shaped bracket 126, as discussed above.

With reference now to FIGS. 4, 5, 6F and 6G, coupling portion 116 of support bracket 110 generally includes a first clamping member 180 and a second clamping member 182. First clamping member 180 includes a curved opening 181 for receiving first azimuth coupler 163 and configured to allow azimuth coupler 163 to translate therein, a first opening 185 configured to receive coupler 161 for coupling first clamping member 180 to U-shaped bracket 126, a U-shaped coupler 183 configured to receive a portion of first actuator 202 such that first actuator 202 may be coupled to and supported by first clamping member 180, a second opening 184 configured to receive a securing pin 205 for coupling first actuator 202 to coupling portion 116 such that first actuator 202 may be secured to coupling portion 116, a third opening 189 configured to receive a second azimuth coupler 167 which may be fixedly or pivotally coupled to first clamping member 180, and at least one fourth opening 186 for receiving a coupler 187 for coupling first clamping member 180 to second clamping member 182. In various embodiments, first clamping member 180 includes two openings 186 for receiving two separate couplers 187 for coupling first clamping member 180 to second clamping member 182 at two separate points.

Still referring to FIGS. 4, 5, 6F and 6G, second clamping member 182 of coupling portion 116 generally includes at least one opening 188 for receiving coupler 187 for coupling second clamping member 182 and first clamping member 180 together. Similar to first clamping member 180, second clamping member 182 may include two openings 188 for receiving two separate couplers 187 for coupling second clamping member 182 and first clamping member 180 together at two separate points. In various embodiments, first and second clamping members 180 and 182 may also each include a curved interior surface configured to complement an exterior surface of main support 112 so that the curved interior surface of first and second clamping members 180 and 182 may abut main support 112 in order for first and second clamping member 180 and 182 to be coupled together and clamped onto main support 112. With clamping members 180 and 182 clamped onto main support 112, main support 112 can support antenna 104, radio 106, coupling bracket 109, and main bracket portion 114.

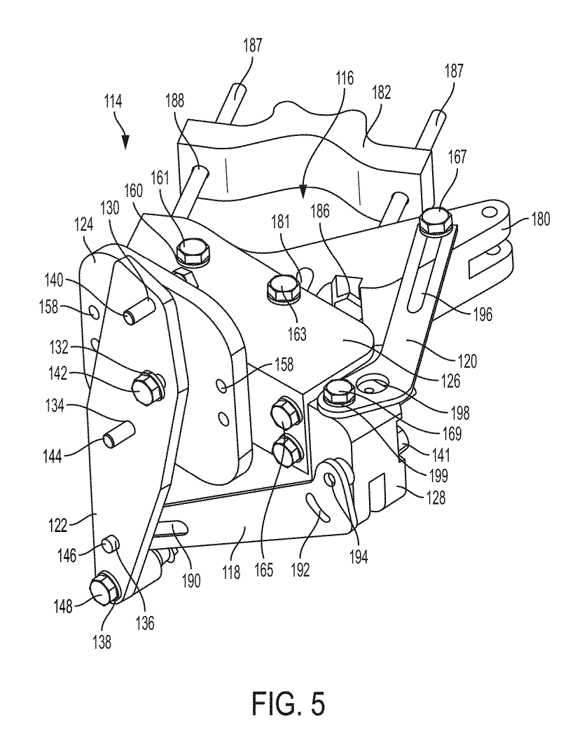

Referring now to FIGS. 4 and 5, elevation link 118 of support system 108 is configured to couple to actuator support portion 128 and elevation pivot plate 122, and includes an elongated slot 190 for receiving third elevation coupler 146, a curved slot 192 for receiving pin 210 of second actuator 204, and an opening 194 configured to receive coupler 141 for coupling elevation link 118 to actuator support portion 128. In various embodiments, elevation link 118 is configured to pivot about coupler 141 and elongated slot 190 is configured to allow movement of elevation pivot plate 122 without similar movement of elevation link 118. Similarly, azimuth link 120 of support system 108 is configured to couple to actuator support portion 128 and coupling portion 116, and generally includes an elongated slot 196 for receiving second azimuth coupler 167, an opening 198 for receiving pin 205 of first actuator 202, and an opening 199 configured to receive coupler 169 for coupling azimuth link 120 to actuator support portion 128. In various embodiments, azimuth link 120 is configured to pivot about coupler 169 and elongated slot 196 is configured to allow movement of coupling portion 116 relative to main bracket 114 without similar movement of azimuth link 120.

### 2. Alignment System

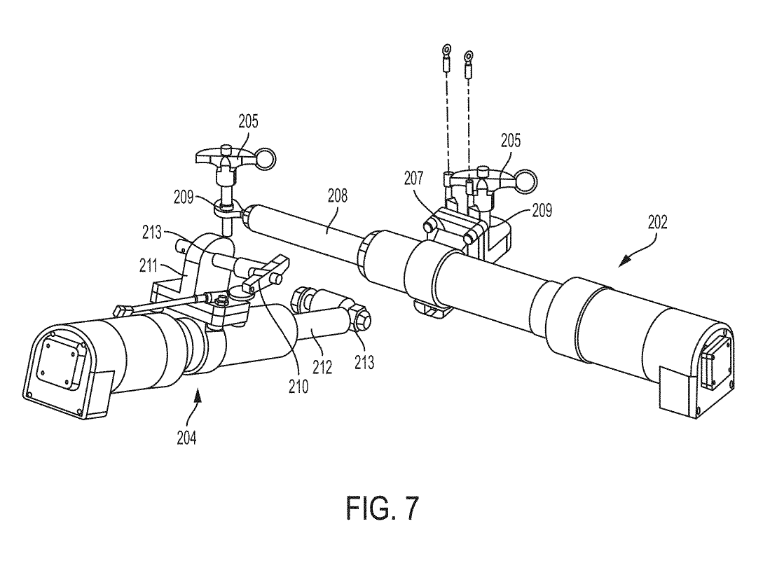

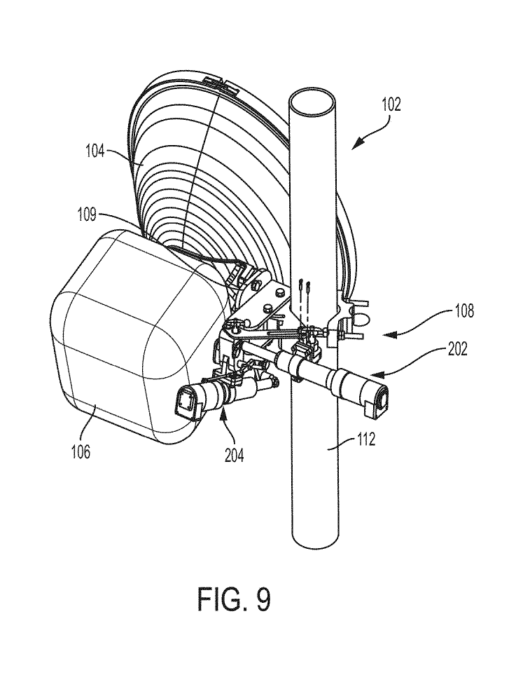

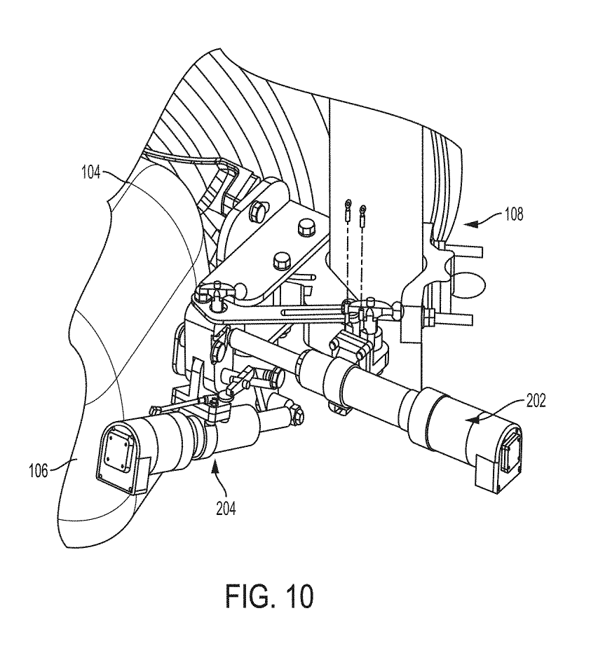

With reference to FIGS. 1 and 7-10, alignment system 200 comprises first actuator 202, second actuator 204, and control unit 206. In general, alignment system 200 enables antenna 104 to scan an azimuth range of ±15 degrees through the actuation of first or azimuth actuator 202 and an elevation range of ±20 degrees through the actuation of second or elevation actuator 204 in order to establish a desired link with another antenna system at a second end of a data link.

First actuator 202 of alignment system 200 generally includes an extendable portion 208 configured to extend and retract, a securing bracket 207 for securing actuator 202 to coupling portion 116, and a plurality of securing pins 205 configured to couple actuator 202 to support system 108. In various embodiments, securing bracket 207 and extendable portion 208 each include an opening 209 configured to receive securing pins 205 when coupling actuator 202 to support system 108. As extendable portion 208 extends and retracts, actuator 202 causes movement of main bracket 114, thereby rotating antenna 104 in the azimuth or horizontal angular direction. Movement of main bracket 114 causes coupling portion 116 and main bracket 114 to move relative to each other such that azimuth couplers 163 and 167 translate within their opening 181 and slot 196, respectively. Thus, in various embodiments, once a link is established between antenna system 102 and the antenna system at the opposite end of the link, azimuth couplers 163 and 167 may be tightened at their respective locations along openings/slot 181 and 196, and antenna system 102 can be held in the position at which a robust and high quality data connection having optimized bandwidth and through-put capability was established.

Second actuator 204 also includes an extendable portion 212 configured to extend and retract, a securing bracket 211 for securing second actuator 204 to actuator support portion 128, and a plurality of securing pins 210 configured to couple second actuator 204 to support system 108. In various embodiments, securing bracket 211 and extendable portion 208 may each include an opening 213 configured to receive securing pins 210 when coupling actuator 204 to support system 108. As extendable portion 212 extends and retracts, actuator 204 causes movement of elevation pivot plate 122, thereby rotating antenna 104 in the elevation or vertical angular direction. Movement of elevation pivot plate 122 causes elevation couplers 140, 144, and 146 to translate within their respective openings/slots 150, 152, and 190. Thus, in various embodiments, once a link is established between antenna system 102 and the antenna system at the opposite end of the link, elevation couplers 140, 144, and 146 may be tightened at their respective locations along openings/slots 150, 152, and 190, and antenna system 102 can be held in the position at which a robust and high quality data connection having optimized bandwidth and through-put capability was established.

In various embodiments, first actuator 202 and second actuator 204 may have any and/or all of the following technical specifications: Travel: 3.75 inch; Force: Peak 225 lbs at 0.40 inches per second and 100 lbs cont.; Backlash: less than 0.005 inch; ARE shelf: locking (max static load 500 lbs); Voltage: 24 VDC; Control protocol: Smart Serial and Universal Serial Bus (USB); Resolution: >0.001-inch.

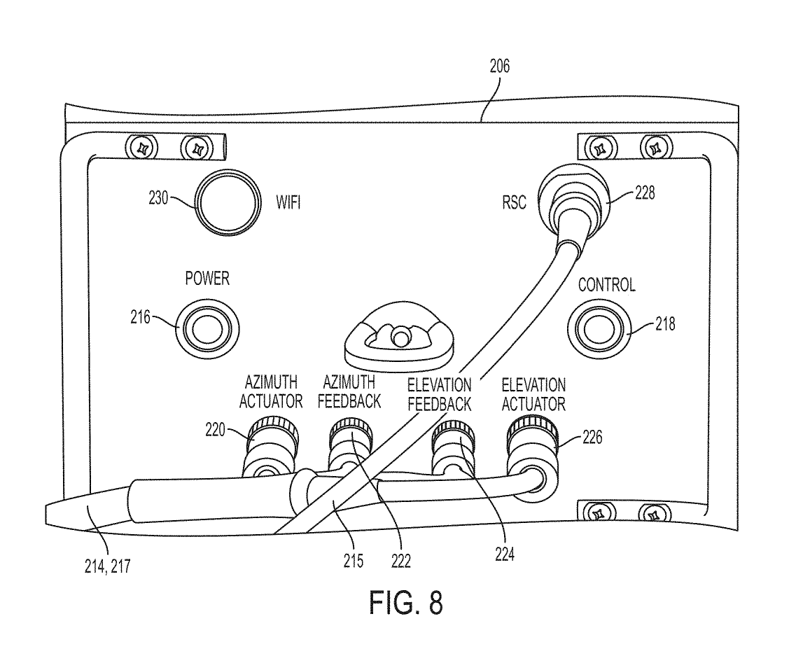

With reference now to FIG. 8, control unit 206 of alignment system 200 is configured to be coupled to first actuator 202, second actuator 204, and radio 106. In various embodiments, control unit 206 may be coupled to first actuator 202, second actuator 204, and radio 106 via cables 214, 215, 217, while in other various embodiments, control unit 206 may be coupled to first actuator 202, second actuator 204, and radio 106 via a wireless connection such that control unit 206 and/or system 100 may be controlled from various remote and/or distant locations. In one embodiment, the wireless connection may be to a web-based system interface such that control unit 206 and/or system 100 may be controlled from a wireless device, for example a cell phone, tablet, or laptop), or a wired device coupled to a wireless connection, for example a desktop computer. In general, control unit 206 is a conventional controller including at least one processor and memory. As used herein, the term controller or control unit may refer to an Application Specific Integrated Circuit (ASIC), an electronic circuit, a processor (shared, dedicated, or group) and memory that execute one or more software or firmware programs/instructions, a combinational logic circuit, and/or other suitable components that provide the described functionality. Control unit 206 may be configured to provide one or more control signals to actuator 202 and/or actuator 204 to cause actuation or movement of the actuators which thereby causes antenna 104 and/or radio 106 to move and be aimed or directionally adjusted in one of an azimuth and/or elevation direction.

Control unit 206 generally includes a power button 216, a control button 218, an azimuth actuator output port 220, an azimuth feedback input port 222, an elevation actuator output port 224, an elevation feedback input port 226, a remote serial communications or RSC port 228, and a wireless network 230. In one embodiment, control unit 206 is a battery powered controller and is configured to supply power to the various components of system 100.

### 3. Operation

With reference to FIG. 1, in operation, alignment system 200 is first coupled to support system 108, antenna 104, and radio 106 or antenna system 102 via cables 214, 215, 217 with elevation couplers 140, 144, and 146 and azimuth couplers 163 and 167 loosened. To begin coupling alignment system 200, azimuth or first actuator 202 and elevation or second actuator 204 are coupled to support system 108. In various embodiments, azimuth actuator 202 is first coupled to support system 108 by coupling portions of actuator 202 to actuator support portion 128 and first clamping member 180 using securing pins 205, and elevation actuator 204 is subsequently coupled to support system 108 by coupling portions of actuator 204 to actuator support portion 128 and elevation pivot plate 122 using securing pins 210. In other various embodiments, elevation actuator 204 is instead coupled to support system 108 first followed by azimuth actuator 202 being coupled to support system 108 second. Then, control cables 217 and feedback cables 214 for each actuator 202, 204 are connected to ports 220, 222, 224, 226 on control unit 206. In various embodiments, control ports 220, 224 and control cables 217a, 217b may be larger than feedback ports 222, 226 and feedback cables 218a, 218b. In addition, cable 215 is connected from radio 106 to RSC port 228 on control unit 206. Furthermore, in various embodiments, radio 106 is connected to the preinstalled intermediate frequency (IF) or Ethernet power cable. Installation of an indoor unit or IDU (not shown) of radio 106, if necessary, should also be completed per manufacturer's installation guide. In one embodiment, control unit 206 may not include cables 214, 215, 217 or ports 220, 222, 224, 226, and may instead be coupled to actuators 202 and 204 and radio 106 via wireless connections.

Once everything is coupled correctly, control unit 206 is powered on by actuating power button 216. Once actuated, power button 216 may illuminate with a flashing light indicating that control unit 206 has initiated the booting process. Once control unit 206 is completely booted, power button 216 will be illuminated with a solid light. In various embodiments, the flashing light around power button 216 may be white, while the solid light around power button 216 may be green. Furthermore, power button 216 may be illuminated with solid lights of different colors to indicate battery life remaining. For example, a green solid light around power button 216 indicates control unit 206 has more than 50% battery life remaining, a yellow solid light indicates control unit 206 has 26%-50% battery life remaining, a red solid light indicates that control unit 206 has 2%-25% battery life remaining, and a flashing red light indicates that control unit 206 has 1% battery life remaining.

After control unit 206 is powered on and control unit 206 is ready to align antenna 204 with the second end of the link, a solid light around control button 218 is illuminated with a white solid light indicating the control unit 206 is in stand by and ready to begin the alignment process of antenna 204 at the actuation of control button 218. Once ready for alignment, control button 218 is actuated, and control unit 206 initiates a software program that scans for a second antenna system at the second end of the link. In various embodiments, the software program may include a wireless search algorithm for control the scanning of antenna 104. The scanning initiated by the software program involves system 100 and the second antenna system scanning along both azimuth and elevation angles. In various embodiments, the software program of control unit 206 causes antenna 104, through actuation of actuators 202 and 204, to scan for the second antenna system at the second end of the link while the second antenna system also scans for antenna 104 until a set threshold signal level is achieved. The set threshold signal level may be any level set or determined by a user of system 100.

To scan the proximate area, antenna 104 is actuated along both the elevation angle or vertical angular direction and the azimuth angle or horizontal angular direction by elevation actuator 204 and azimuth actuator 202 until either the threshold signal level is achieved or the entire area capable of being scanned by antenna 104 has been scanned. For example, actuation of actuators 202 and 204 may cause antenna 104 to scan a plurality of degrees along the azimuth angle. If no link is found, actuation of actuator 202 and 204 may then cause antenna 104 to scan further along the same azimuth angle at a given elevation, or actuation of actuators 202 and 204 may then cause antenna 104 to scan up or down the elevation angle and then scan a plurality of degrees along the azimuth angle again at a second elevation, where the path scanned along the azimuth angle at the first elevation is parallel to the path scanned along the azimuth angle at the second elevation. Once the threshold signal level is achieved, both system 100 and the second antenna system stop. Once targeting of the second antenna system at the second end of the link has occurred, control unit 206 scans the wireless lobes to locate the center point, providing quick network links at the highest throughput possible. For example, each antenna system 102 may adjust in both azimuth and elevation to maximize the signal strength while ensuring a valid link exists, followed by both antenna systems 102 making fine adjustments in both azimuth and elevation to maximize the signal strength while ensuring a valid link exists. If desired, adjustments by antenna systems 102 may be repeated.

In various embodiments, while antenna 204 scans, the light surrounding control button 218 may flash to indicate that scanning is in progress. Furthermore, the light surrounding control button 218 may illuminate green when the link has been established or red if the link cannot be completed. In an exemplary embodiment, the alignment or optimization process takes approximately 20 minutes to complete.

In one embodiment, once alignment is complete and antenna 204 is optimized on the link or a link cannot be established and the user is finished with alignment system 200, alignment system 200 may be dismantled from support system 108, antenna 104, and radio 106. To dismantle alignment system 200, first, elevation couplers 140, 144, and 146 and azimuth couplers 163 and 167 are tightened at their respective positions. In an exemplary embodiment, elevation couplers 140, 144, and 146 are tightened prior to azimuth couplers 163 and 167. Subsequently, cables 214, 215, and 217 are disconnected from control unit 206. Then, elevation actuator 204 is removed followed by azimuth actuator 202. In various embodiments, cables 214, 215, and 217, actuators 202 and 204, and control unit 206 may be stored in a transport case (not shown) to protect system 200 in transport.

In another embodiment, actuators 202 and 204 may remain coupled to antenna 104 and/or radio 106 such that antenna alignment system 100 may continuously and/or automatically align antenna 104. To do so, control unit 206 communicates with radio 106 to determine a radio signal strength indicator (SSI) value and/or whether a link is available, and control unit 206 and/or radio 106 continuously monitor the signal. If the signal drops below a defined threshold value, control unit 206 actuates alignment system 100 to reoptimize the link. In order to reoptimize the link, the second antenna system makes large sweeps along the azimuth and elevation angles. Subsequently, system 100 moves in both azimuth and elevation to refine the link.

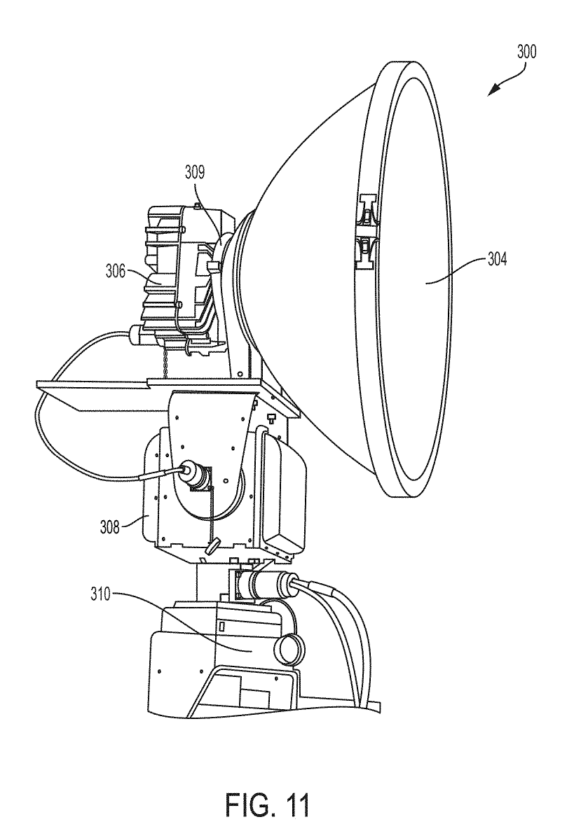

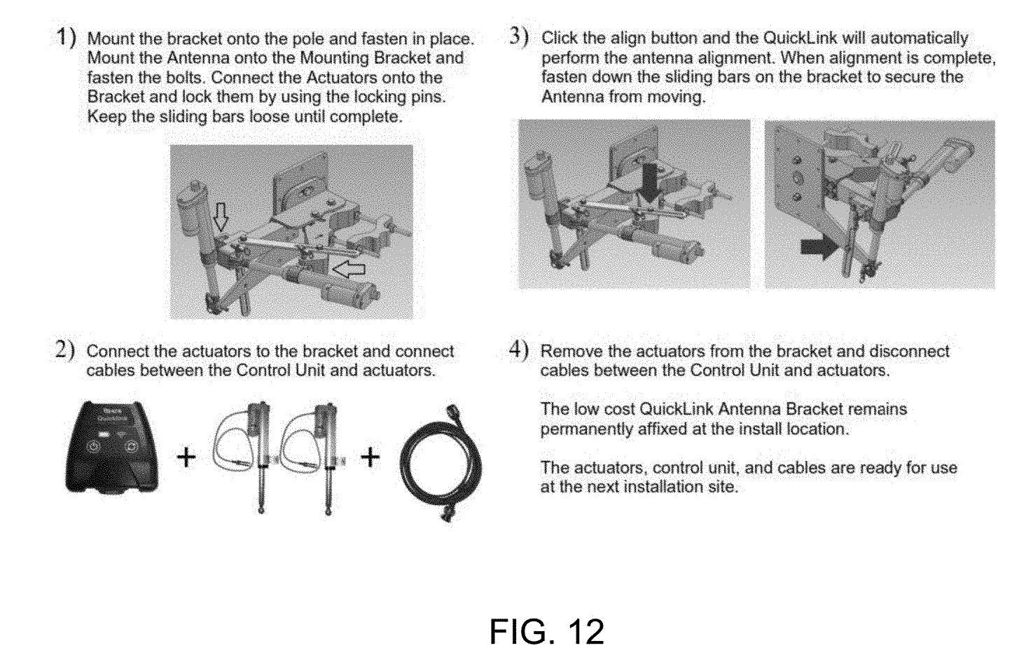

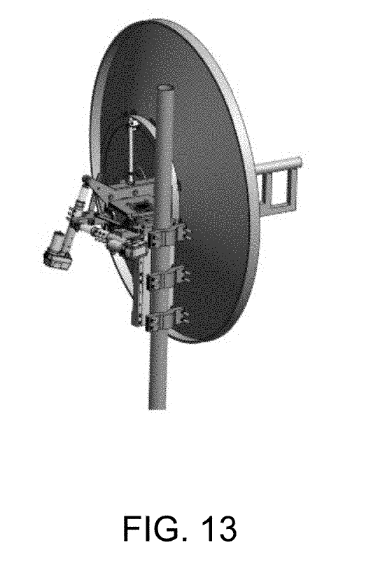

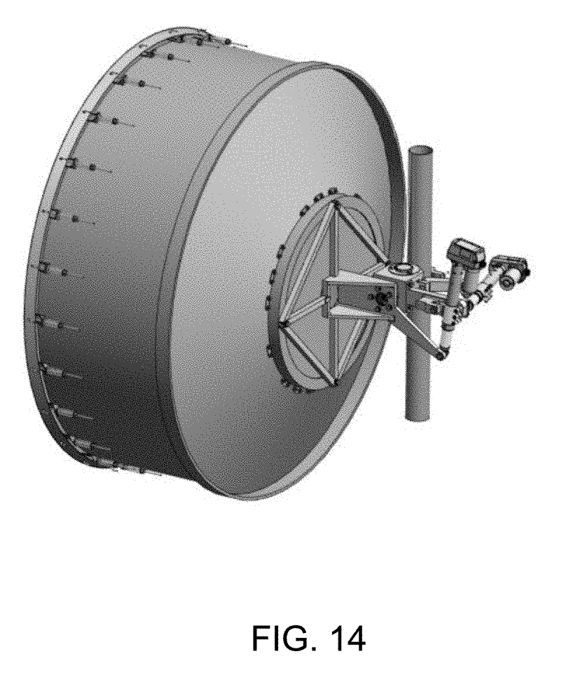

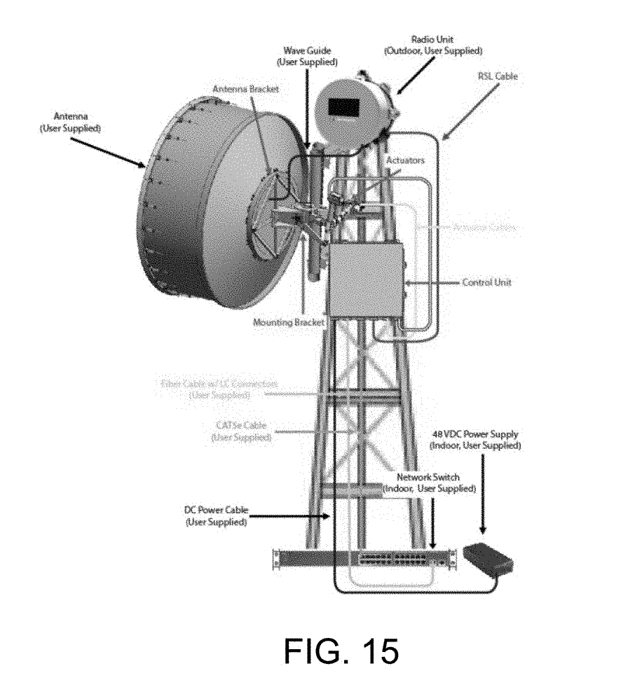

In various embodiments of the present disclosure, alignment system 200 may be internal to control unit 206 and continuously coupled to antenna 104 and radio 106 such that system 100 may automatically align antenna 104. With reference to FIG. 11, an embodiment of an continuous autopoint system 300 of the present disclosure is shown. Continuous autopoint system 300 generally includes antenna 304, radio 306, and coupling bracket 309 similar to system 100 along with a positioning unit 308 along which includes control unit 206 and alignment system 200. Continuous autopoint system 300 may be supported by support bracket 310, which may be coupled to positioning unit 308, and coupling bracket 309 which couples positioning unit 308 to antenna 304 and/or radio 306. In various embodiments, continuous autopoint system 300 is configured to continuously monitor the radio signal and align antenna 304 to the peak signal strength, mitigating factors such as fluctuations based on thermal expansion of the main support, wind events or other environmental conditions, and eliminating downtime and reoccurring cost due to manual re-alignment.

In the foregoing specification, specific embodiments of the present disclosure have been described. However, one of ordinary skill in the art will appreciate that various modifications and changes can be made without departing from the scope of the disclosure as set forth in the claims below. Accordingly, the specification and figures are to be regarded in an illustrative rather than a restrictive sense. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued. No claim element herein is to be construed under the provisions of 35 U.S.C. 112(f) unless the element is expressly recited using the phrase “means for.”

1. An antenna alignment system comprising:
an antenna system including an antenna and a support system; and
an alignment system including at least one actuator and a control unit, wherein the at least one actuator is configured to be coupled to the support system, and the control unit is configured to actuate the at least one actuator such that the antenna is moved in at least one direction.

2. The antenna alignment system of claim 1, wherein the at least one actuator includes a first actuator and a second actuator.

3. The antenna alignment system of claim 2, wherein the at least one direction includes a first direction and a second direction, and the first actuator is configured to pivot the antenna in the first direction and the second actuator is configured to pivot the antenna in the second direction.

4. The antenna alignment system of claim 3, wherein the first direction is along an azimuth angle and the second direction is along an elevation angle.

5. The antenna alignment system of claim 1, wherein the antenna is a microwave antenna.

6. The antenna alignment system of claim 1, wherein the at least one actuator is temporarily coupled to the support system, and the control unit is configured to actuate the at least one actuator to move the antenna in the at least one direction when the at least one actuator is temporarily coupled to the support system.

7. The antenna alignment system of claim 1, wherein the at least one actuator is continuously coupled to the support system.

8. The antenna alignment system of claim 1, wherein the support system includes a support bracket having a plurality of azimuth couplers capable of translating within openings in the support bracket and a plurality of elevation couplers capable of translating within openings in the support bracket.

9. The antenna alignment system of claim 8, wherein the support bracket includes a main bracket, a coupling portion, an elevation link, and an azimuth link, wherein the main bracket includes an elevation pivot plate, a support plate, and a U-shaped bracket.

10. The antenna alignment system of claim 1, wherein the control unit includes a wireless search algorithm configured to transmit instructions to the alignment system to actuate the at least one actuator such that the antenna is moved in the at least one direction.

11. A method for aligning a first antenna system with a second antenna system to establish a link comprising:
coupling an alignment system comprising at least one actuator and a control unit to the first antenna system, wherein the first antenna system comprises an antenna and a support system;
initiating a software program within the control unit;
transmitting instructions from the control unit to the alignment system to actuate the at least one actuator;
actuating the at least one actuator whereby the actuation of the at least one actuator causes the first antenna system to pivot and scan for the second antenna system in at least one direction; and
removing the alignment system after the first antenna system is linked to the second antenna system.

12. The method of claim 11, wherein the at least one actuator includes a first actuator and a second actuator.

13. The method of claim 12, wherein the at least one direction includes a first direction and a second direction, and the first actuator is configured to cause the antenna to scan in the first direction and the second actuator is configure to cause the antenna to scan in the second direction.

14. The method of claim 13, wherein the first direction is along an azimuth angle and the second direction is along an elevation angle.

15. The method of claim 14, wherein the first actuator causes the antenna to scan the azimuth angle for a range of ±15 degrees and the elevation angle for a range of ±20 degrees.

16. The method of claim 14, wherein the antenna scans a first path along the azimuth angle for a plurality of degrees, and if no link is found, then the antenna scans the elevation angle for at least one degree before scanning a second path along the azimuth angle for a plurality of degrees, wherein the first path and the second path are parallel to one another.

17. The method of claim 11, wherein the software program includes a wireless search algorithm, whereby the control unit transmits the instructions to the alignment system to actuate the at least one actuator such that the antenna pivots and scans for the second antenna system in order to establish the link.

18. An apparatus for aligning a first antenna with a second antenna to establish a link between the first antenna and the second antenna comprising:
a first actuator configured to pivot the first antenna in a first direction;
a second actuator configured to pivot the first antenna in a second direction; and
a control unit coupled to the first actuator and the second actuator and configured to actuate the first and second actuators such that the first antenna pivots and scans for the second antenna to establish the link, wherein the first actuator, the second actuator, and the control unit are removed from the first antenna once the link is established.

19. The apparatus of claim 18, wherein the first actuator is configured to pivot the first antenna along an elevation angle, and the second actuator is configured to pivot the first antenna along an azimuth angle.

20. The apparatus of claim 18, wherein the control unit is coupled to the first actuator, the second actuator, and a radio coupled to the first antenna.
